(19) United States
(12) Patent Application Publication
(10) Pub. No.: US 2019/0250876 A1
(43) Pub. Date: Aug. 15, 2019

(54) SPLIT READ TRANSACTIONS OVER AN AUDIO COMMUNICATION BUS

(71) Applicant: QUALCOMM Incorporated, San Diego, CA (US)

(72) Inventors: Lior Amarilio, Yokneam (IL); Sharon Graif, Zichron Yaakov (IL); Shaul Yohai Yifrach, Haifa (IL)

(21) Appl. No.: 16/260,299

(22) Filed: Jan. 29, 2019

Related U.S. Application Data
(60) Provisional application No. 62/630,152, filed on Feb. 13, 2018.

(51) Int. Cl. G06F 3/16

(52) U.S. Cl. CPC G06F 3/162; G06F 2213/0026; G06F 2213/0002

(57) ABSTRACT

Systems and methods for providing split read transactions over an audio communication bus are disclosed. In one aspect, a device that receives a read command informs a requester that data is not yet available and to try again at a future time, potentially outside the traditional response window. In the meantime, the receiving device begins fetching the requested data to have available when the requester makes a subsequent request. By providing a not yet response, data may be fetched from a memory element in a low-power state after it has been taken out of the low-power state or data may be fetched from a remote location or over a slow internal bus.

### PRIORITY CLAIM

The present application claims priority to U.S. Provisional Patent Application Ser. No. 62/630,152, filed on Feb. 13, 2018 and entitled “SPLIT READ TRANSACTIONS OVER AN AUDIO COMMUNICATION BUS,” the contents of which is incorporated herein by reference in its entirety.

### BACKGROUND

### I. Field of the Disclosure

The technology of the disclosure relates generally to read transactions over an audio bus and, more particularly, to read transactions over a SOUNDWIRE audio bus.

### II. Background

Computing devices are commonplace in modern society. In particular, mobile computing devices such as smart phones and tablets have become increasingly popular with consumers. Such portable computing devices have evolved from simple telephony devices to complex multimedia platforms. In an effort to support multimedia functionality, industry groups have proposed various standards and specifications. One popular audio bus standard is the SOUNDWIRE specification proposed by the MIPI Alliance in 2014. Version 1.1 of the SOUNDWIRE specification was published to MIPI members in August 2016.

SOUNDWIRE contemplates a master with a plurality of slaves coupled through a multi-wire bus. One function that SOUNDWIRE contemplates is a read command where data may be retrieved from a device and provided to a requesting device. SOUNDWIRE mandates that a device return the data value within a few clock cycles from the time the read command was delivered (sometimes referred to as a “response window”). When SOUNDWIRE was originally proposed, devices were designed to comply with this mandate.

However, as the flexibility of SOUNDWIRE has been discovered, there has been a desire to use SOUNDWIRE with devices that may have data that is not immediately accessible, such as when a device is coupled to a memory element through a bridge or slow internal bus. Further, in an effort to conserve power, many devices are frequently put into a low-power state. If a memory element associated with a device is put into such a low-power state, it may not be possible to wake the memory and provide the data within the response window. Accordingly, there needs to be a technique to provide greater flexibility in responding to read commands in a SOUNDWIRE system.

### SUMMARY OF THE DISCLOSURE

Aspects disclosed in the detailed description include systems and methods for providing split read transactions over an audio communication bus. In particular, exemplary aspects of the present disclosure allow a device that receives a read command to inform a requester that data is not yet available and to try again at a future time, potentially outside the traditional response window. In the meantime, the receiving device begins fetching the requested data to have available when the requester makes a subsequent request. By providing a not yet response, data may be fetched from a memory element in a low-power state after it has been taken out of the low-power state or data may be fetched from a remote location or over a slow internal bus.

In this regard, in one aspect, a method of responding to a read command received from a master over an audio bus is disclosed. The method includes determining that data responsive to the read command is not available within a response window. The method also includes returning a not yet response to the master.

In another aspect, a method for reading data from a device across an audio bus is disclosed. The method includes sending a read command to the device across the audio bus. The method also includes receiving a not yet response from the device. The method also includes sending a subsequent read command to the device.

In another aspect, an integrated circuit (IC) operating as a master on an audio bus is disclosed. The IC includes a bus interface coupled to the audio bus. The IC also includes a control system coupled to the bus interface. The control system is configured to send a read command to a device across the audio bus. The control system is also configured to receive a not yet response from the device. The control system is also configured to send a subsequent read command to the device.

In another aspect, an IC operating as a slave on an audio bus is disclosed. The IC includes a bus interface coupled to the audio bus. The IC also includes a control system coupled to the bus interface. The control system is configured to determine that data responsive to a read command is not available within a response window. The control system is also configured to return a not yet response to a master.

### BRIEF DESCRIPTION OF THE FIGURES

FIG. 1 is a block diagram of an exemplary computing device with an audio bus and associated components;

FIG. 2 is a block diagram of a device having a slow internal bus that could be coupled to the audio bus of FIG. 1;

FIG. 3 is a block diagram of two cascaded devices where a first one of the devices could be coupled to the audio bus of FIG. 1;

FIGS. 4A-4C illustrate various portions of a control word frame used on an audio bus;

FIG. 5 is a flowchart illustrating an exemplary process for an initial response to a read command according to exemplary aspects of the present disclosure;

FIG. 6 is a flowchart illustrating an exemplary process for fetching data and then responding to a read command when there is a slow internal bus in the device;

FIG. 7 is a flowchart illustrating an exemplary process for fetching data and then responding to a read command when a memory element is in a low-power state;

FIG. 8 is a flowchart illustrating an exemplary process for fetching data and then responding to a read command when a memory element is located across a secondary bus;

FIG. 9 is a flowchart illustrating an exemplary process for resending read commands in response to receiving a not yet response from a device;

FIG. 10 is a flowchart illustrating an exemplary process for resending read commands in response to receiving a not yet response coupled with an interrupt from a device; and

FIG. 11 is a block diagram of an exemplary processor-based system that can include the audio bus of FIG. 1 and the devices of FIGS. 2 and 3 and/or implement the processes of FIGS. 5-10.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include systems and methods for providing split read transactions over an audio communication bus. In particular, exemplary aspects of the present disclosure allow a device that receives a read command to inform a requester that data is not yet available and to try again at a future time, potentially outside the response window. In the meantime, the receiving device begins fetching the requested data to have available when the requester makes a subsequent request. By providing a not yet response, data may be fetched from a memory element in a low-power state after it has been taken out of the low-power state or data may be fetched from a remote location or over a slow internal bus.

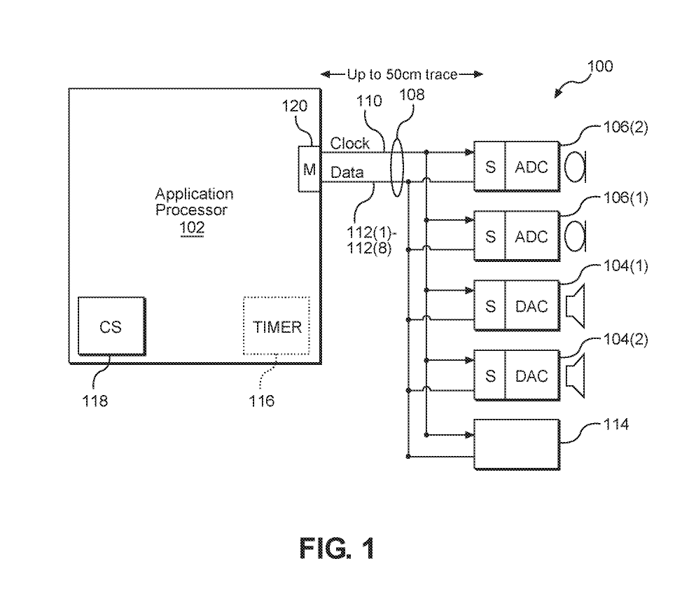

In this regard, FIG. 1 is block diagram of an exemplary audio system 100. In a specifically contemplated aspect, the audio system 100 is a SOUNDWIRE audio system. The audio system 100 includes an integrated circuit (IC) 102, which may be an application processor, coupled to a plurality of microphones 104(1)-104(2) and a plurality of speakers 106(1)-106(2) by a multi-wire audio bus 108. The multi-wire audio bus 108 includes a clock line 110 and one or more (up to eight) data lines 112(1)-112(8). In addition to the plurality of microphones 104(1)-104(2) and the plurality of speakers 106(1)-106(2), the multi-wire audio bus 108 may be further connected to other devices such as a device 114, which may be a codec or the like. It should be appreciated that the device 114 may be a second IC. As explained in greater detail below, the device 114 may have memory elements associated therewith, which are accessed by the IC 102. The IC 102 is generally regarded as a master of the audio system 100, and the plurality of microphones 104(1)-104(2), the plurality of speakers 106(1)-106(2), and the device 114 are slaves. While illustrated as the application processor, the IC 102 could be replaced by a codec and the device 114 could be some other element (not illustrated). In some aspects, the IC 102 may include a timer 116. The IC 102 may further include a control system 118, which may be one of a plurality of processing cores within the IC 102 or other logic elements necessary and sufficient to implement the functional attributes associated with operation of the audio system 100. Further, the IC 102 includes a bus interface 120, which may be a physical layer (PHY) configured to couple to the multi-wire audio bus 108. While not specifically illustrated in FIG. 1, it should be appreciated that the slave devices likewise have bus interfaces and may or may not include a control system.

More information on the SOUNDWIRE specification may be found at Specification for SOUNDWIRE, version 1, released Jan. 21, 2015, available at members.mipi.org/wg/LML/document/folder/8154 to MIPI members. The SOUNDWIRE specification is incorporated by reference in its entirety.

While aspects of the present disclosure are well suited for use in a SOUNDWIRE system, it should be appreciated that the concepts described herein could also be applicable to other audio buses. Further note that while the various SOUNDWIRE buses illustrated herein have a two-wire clock/data configuration, exemplary aspects of the present disclosure are also applicable to proposed differential configurations that have a two-wire D+/D− configuration.

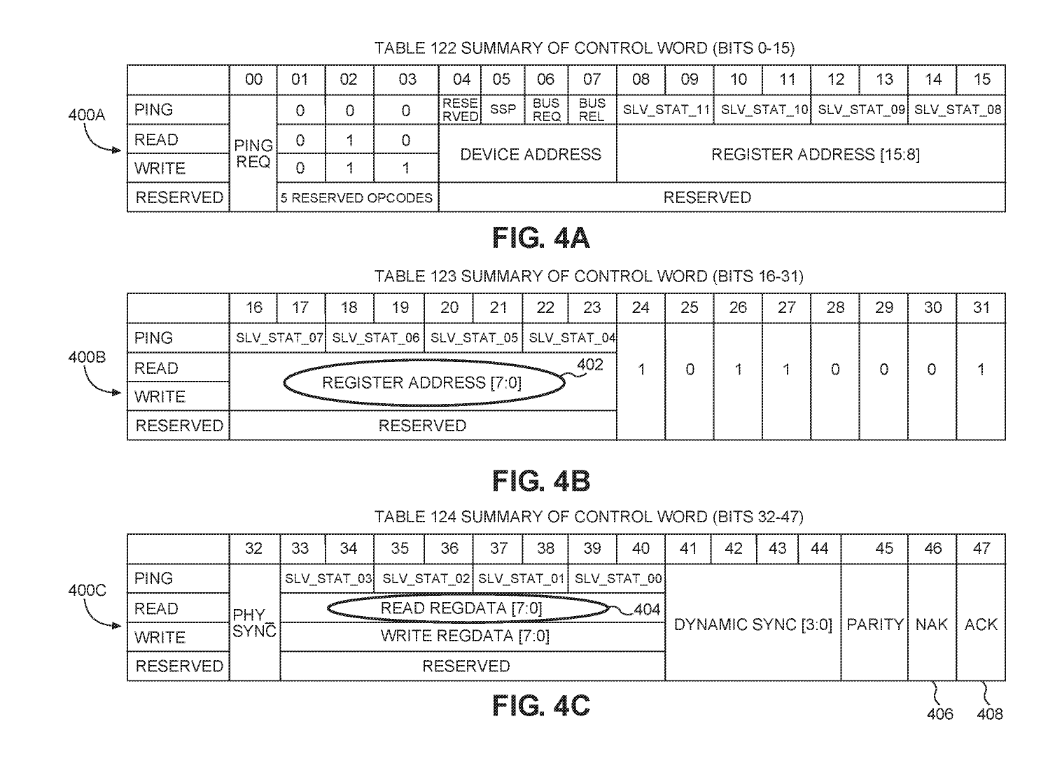

The SOUNDWIRE specification defines a frame having multiple lanes (up to eight) and a fixed “control word,” which will always appear on column 0 of the frame. In practice, each lane is assigned to one of the one or more data lines 112(1)-112(8) of the multi-wire audio bus 108. The frame has rows and columns. In each row, bit slots are provided that may change from any source to any other source. More detail about the frame used in a SOUNDWIRE system is set forth with reference to FIGS. 4A-4C below.

From time to time, the master, such as the IC 102, may request data from one of the slave devices through a read command. In a conventional SOUNDWIRE system, the slave must respond with the requested data within a very short time frame (e.g., nine clock cycles, also referred to as the “response window”). There are instances when this level of response is not possible within the response window.

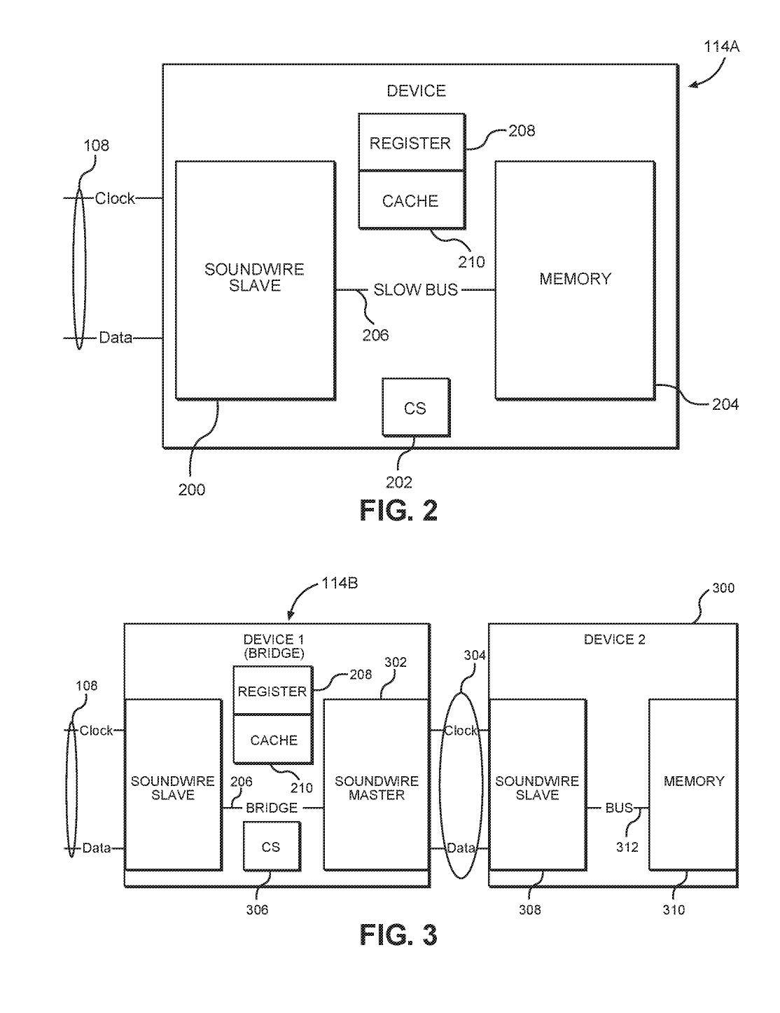

FIGS. 2 and 3 illustrate variations of the device 114 that may not be able to respond to a read command within a short time period and are amenable to using aspects of the present disclosure. In particular, FIG. 2 illustrates a simplified block diagram of a device 114A that is a slave to the multi-wire audio bus 108. As noted above, the multi-wire audio bus 108 may have a clock/data configuration or a differential D+/D− configuration. The device 114A includes a bus interface or PHY 200 that is configured to couple to the multi-wire audio bus 108 and may have a control system 202 that is a processing core or other logic element as needed or desired. The device 114A may be a codec or other IC as needed or desired. The device 114A may include a memory element 204 that has data responsive to read commands from the master (e.g., the IC 102). The memory element 204 may be coupled to the PHY 200 through a slow internal bus 206. In a related situation, the bus 206 may not be slow, but the memory element 204 may be in a low-power or sleep mode and it may take more than the allocated time to wake the memory element 204. In either event, the device 114A may not be able to comply with the timing requirement set forth in the SOUNDWIRE specification (i.e., the response is not available within the response window). The device 114A may further include an immediately available register 208 that is not in a low-power state and is not accessed through the slow internal bus 206. The device 114A may further include a cache memory 210 that has temporarily stored data from the memory element 204, and thus, represents data that is immediately available even though the memory element 204 may be asleep or accessed through the slow internal bus 206. In exemplary aspects of the present disclosure, the cache memory 210 may have a register (RegAddr) that can be set to one of three states—empty (i.e., there is a miss and there is no data available for this RegAddr), valid (i.e., there is a hit where data is available for this RegAddr), and pending (i.e., the data is not yet valid because the device is in the process of fetching the data to this RegAddr).

FIG. 3 illustrates another situation where the timing requirement of the response window may not be met. In FIG. 3, a device 114B is coupled to the multi-wire audio bus 108 through the PHY 200 (illustrated in FIG. 1), and is also coupled to a second IC 300 through a second PHY 302. In an exemplary aspect, the device 114B is a slave relative to the IC 102, but a master relative to the second IC 300. A bus 304 may interconnect the device 114B with the second IC 300. The bus 304 may be a SOUNDWIRE bus or other bus. Again, as noted above, the bus 304 may have a clock/data configuration or a differential D+/D− configuration. As with the device 114A, the device 114B may include a control system 306 that may be a processing core or the like. The second IC 300 may include a PHY 308 and a memory element 310. The memory element 310 may hold the data that is responsive to a read command received at the device 114B. Given the intervening buses (e.g. the internal buses 206 and 312), it may not be possible to retrieve data in the memory element 310 in a timely fashion.

Exemplary aspects of the present disclosure allow a device such as the devices 114, 114A, and 114B to respond to a read command with a “not yet” response. This informs the master that sent the read command that the device cannot provide the data within the response window, and that the master may initiate a subsequent read command while the device fetches the data. Depending on the nature of the reason that the data is not readily available, the device may behave differently during the fetching process. Further, the master may initiate the subsequent read command after a variety of triggers. By allowing the device to defer responding to the read command to a time outside the response window, operation is improved in that the data is still provided to the master such that the master may continue operation and the master will know where to look for the data at the subsequent time.

FIGS. 4A-4C illustrate portions 400A-400C of a SOUNDWIRE control word frame. In portion 400B of FIG. 4B, the master may issue a read command 402 in bits 16-23. Normally, within the response window, a read response 404 is provided in bits 33-40. Also of interest are a negative acknowledgement (NAK) bit 406 and an acknowledgement (ACK) bit 408.

In exemplary aspects of the present disclosure, the device responds with a not yet response when the device is unable to provide the data responsive to the read command 402 in the response window by setting the NAK bit 406 and the ACK bit 408 to zero (0). A master that has not implemented the teachings of the present disclosure that receives such a not yet response will ignore the response, because as published, the SOUNDWIRE specification requires a device to answer either a NAK or an ACK, and if neither are asserted by the device (i.e., NAK=ACK=0, which in a No-Return-to-Zero Interface (NRZI) encoding, a value of zero means no one drives the bus), then it is similar to the case that the device is no longer on the bus. However, a master that implements aspects of the present disclosure will receive the not yet response and provide a subsequent read command to acquire the data after the device has fetched the data.

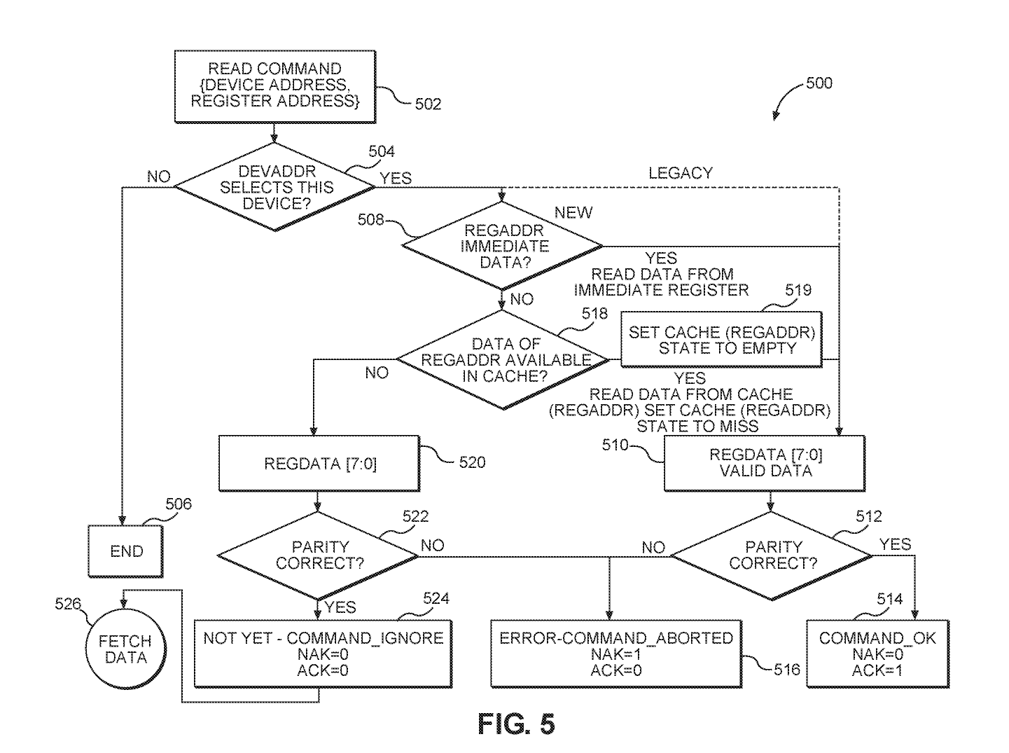

The processes of the device and the master are set forth in FIGS. 5-10 with variations depending on from where the data is fetched and how the master initiates the resending of the read command.

In this regard, FIG. 5 is a flowchart of a process 500 illustrating the behavior of the device in response to a read command when the device does not have the data readily available within the response window. The process 500 begins with a read command including a device address and a register address (block 502). The device examines the device address and determines if the device address selects the device (block 504). If the answer to block 504 is no, then the device ends the process (block 506) because the read command is not for that device. If, however, the answer to block 504 is yes, then the device determines if the register address reflects data that is in an immediately available register (e.g., the register 208) (block 508). If the answer to block 508 is yes, the data is immediately available, then the device sets the bits 33-40 (element 404 of FIG. 4C) with the data from the register 208 (block 510). The device then checks to see if the parity bit is correct (block 512). If the answer to block 512 is yes, then the device sets a Command_OK response by setting the NAK bit to zero (0) and the ACK bit to one (1) (block 514). If the parity bit is not correct, then the device sets an ERROR-command aborted response by setting the NAK bit to one (1) and the ACK bit to zero (0) (block 516).

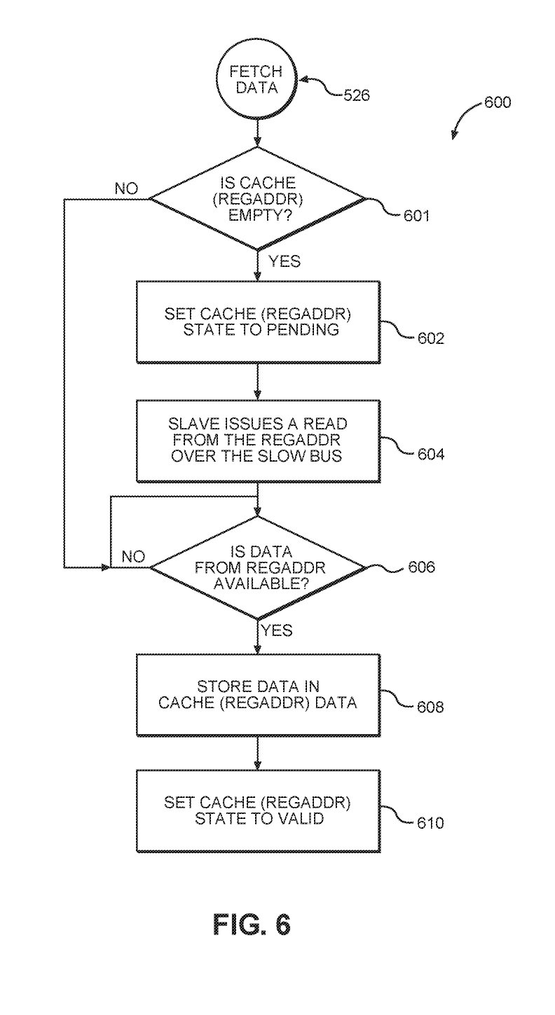

With continued reference to FIG. 5, if the data is not available in the immediate register 208, then the device determines if the data is available in the cache memory 210 (block 518) (i.e., cache (RegAddr) is valid). If the answer to block 518 is yes, then the process 500 initially sets the cache (RegAddr) state to empty (block 519) and moves to block 510 as previously described. Note that legacy devices will go from block 504 to block 510 without the checks of blocks 508 and 518. If the answer to block 518 is no, the data is not available in the cache memory 210, then the process 500 concludes that the RegData requested is not available (block 520). The device checks that the parity is correct (block 522). If the answer is no, then the device returns an error (block 516). If however, the parity is correct, then the device returns a not yet response (block 524) by setting the NAK bit to zero (0) and the ACK bit to zero (0). The device then begins fetching the data (block 526). The way in which the device fetches the data may vary depending on where the data is located. FIGS. 6-8 illustrate exemplary ways to fetch data.

In this regard, FIG. 6 illustrates a process 600 where the device is fetching data across the slow internal bus 206. The process 600 begins by determining if the cache (RegAddr) is empty (block 601). If the answer to block 601 is yes, then the control system sets the cache (RegAddr) state to pending (block 602). The slave (e.g., the device 114A) issues a read command from the register address over the slow internal bus 206 (block 604). The control system monitors whether the data is available (block 606). Likewise, if the answer to block 601 is no, then the process 600 also goes to block 606. When the data becomes available, it is stored in the cache memory 210 (block 608) and the control system sets the cache (RegAddr) state to valid (block 610) indicating that the data is immediately available when the read command is resubmitted.

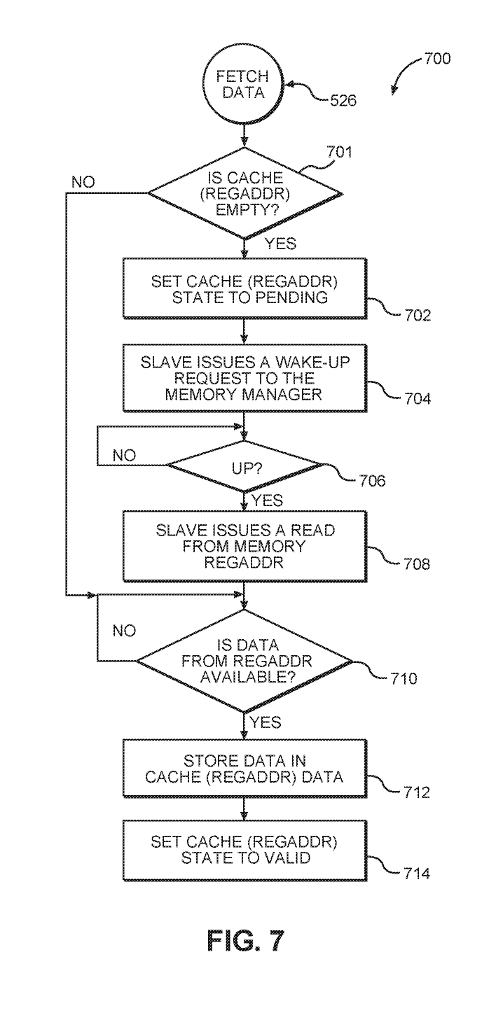

If the device has a memory element in a low-power state, process 700 of FIG. 7 is used to fetch the data. The process 700 begins by determining whether the cache (RegAddr) state is empty (block 701). If the answer to block 701 is yes, the control system sets the cache (RegAddr) state to pending (block 702), indicating that the data is not immediately available within the response window. The device issues a wake-up request to a memory manager for the memory element 204 (block 704). The control system monitors whether the memory element 204 is up (block 706), i.e., awake. When the memory element 204 is up, the device issues a read command from memory using the RegAddr (block 708). If the answer to block 701 is no, or the slave issues the read command, the control system monitors for when the data from RegAddr is available (block 710) and once the data is available, the data is stored in the cache memory 210 (block 712) with the appropriate pointer by setting the cache (RegAddr) state to valid (block 714) indicating that the data is immediately available when the read command is resubmitted.

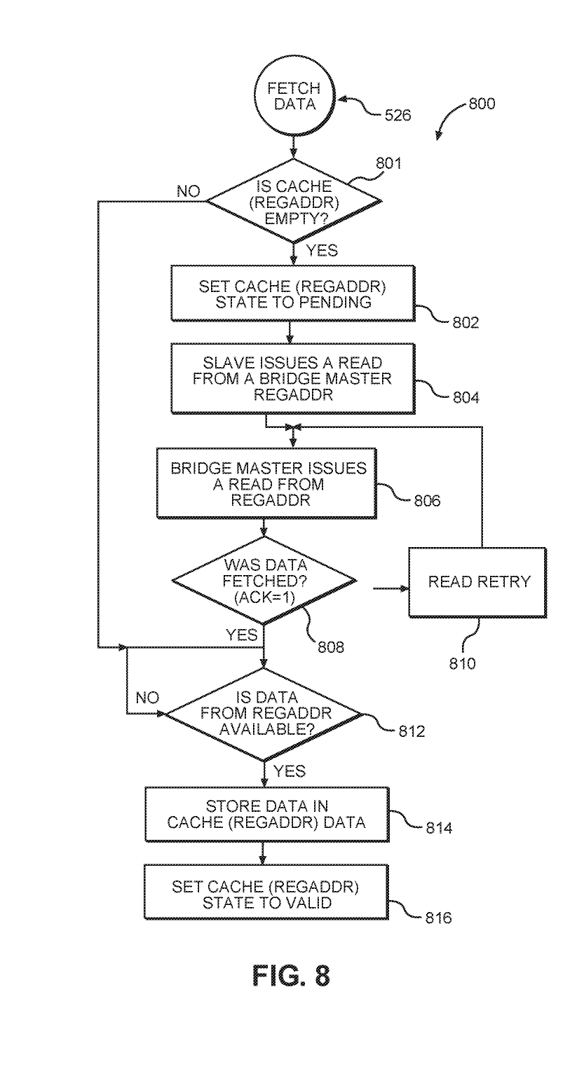

If the device has to go through an external bus such as the bus 304, then process 800 of FIG. 8 is used to fetch the data. The process 800 begins by determining whether the cache (RegAddr) state is empty (block 801). If the answer to block 801 is yes, the control system sets the cache (RegAddr) state to pending (block 802). The slave issues a read command from a bridge master (e.g., the second PHY 302 and associated circuitry) RegAddr (block 804). The bridge master issues a read from RegAddr command (block 806) across the bus 304. The bridge master checks to see if the data was fetched (block 808) and retries with a new read command if the answer is no (block 810) until the answer is yes. If the answer to block 801 is no, or the control system gets a yes at block 810, the control system checks to see if the data from RegAddr is available (block 812) until it is, at which point, the data is stored in the cache memory 210 (block 814), and the control system sets the cache (RegAddr) state to valid (block 816).

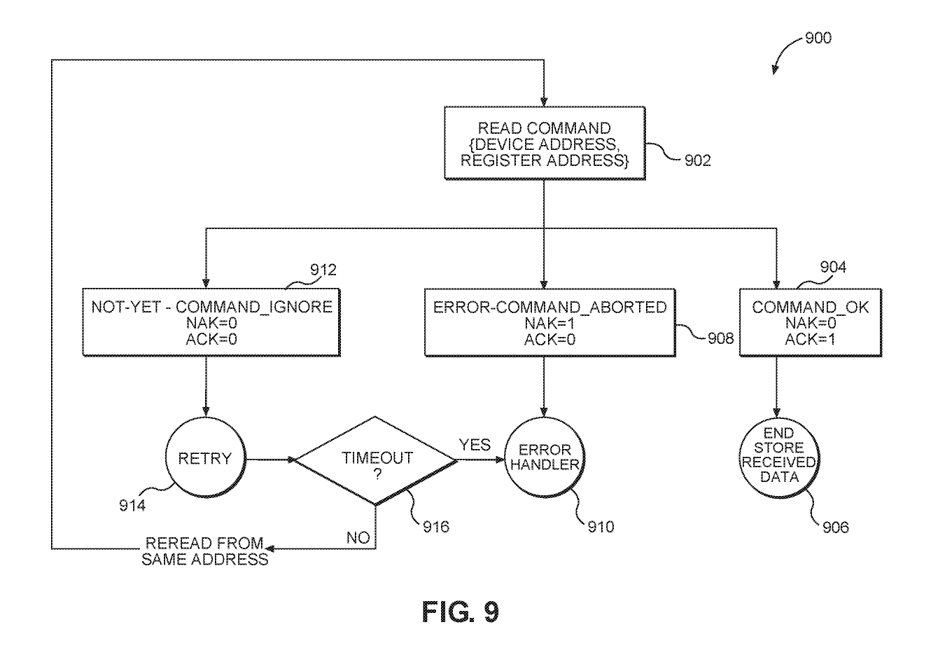

On the master side, there are a few changes to how read commands are handled. In a first exemplary aspect, the master merely resends the read command as soon as it receives the not yet response. This process is illustrated as process 900 in FIG. 9. The process 900 begins with a read command being sent by the master (block 902). The read command includes a device address and a register address. This read command is received by the device and a response generated by the device as explained above. If the data requested is immediately available, the data is returned with a Command_OK response (block 904) indicated by NAK=0 and ACK=1. The master stores the received data (block 906) and the process ends.

With continued reference to FIG. 9, if there is an error (e.g., a parity error or the like), then the device returns an error, by setting NAK=1 and ACK=0 (block 908). An error handler is invoked (block 910) and the error is processed according to the SOUNDWIRE specification. If, however, a not yet response is received (block 912) as indicated by NAK=0 and ACK=0, then the master retries (block 914). In a first exemplary aspect, the retry is initiated as soon as the not yet response is received. A timer such as the timer 116 may start running to check to see if a timeout value is reached (block 916). If no retry is successful before the timeout value is exceeded, an error may be generated for the error handler (block 910). If the timeout value has not been exceeded, the read command is regenerated at block 902.

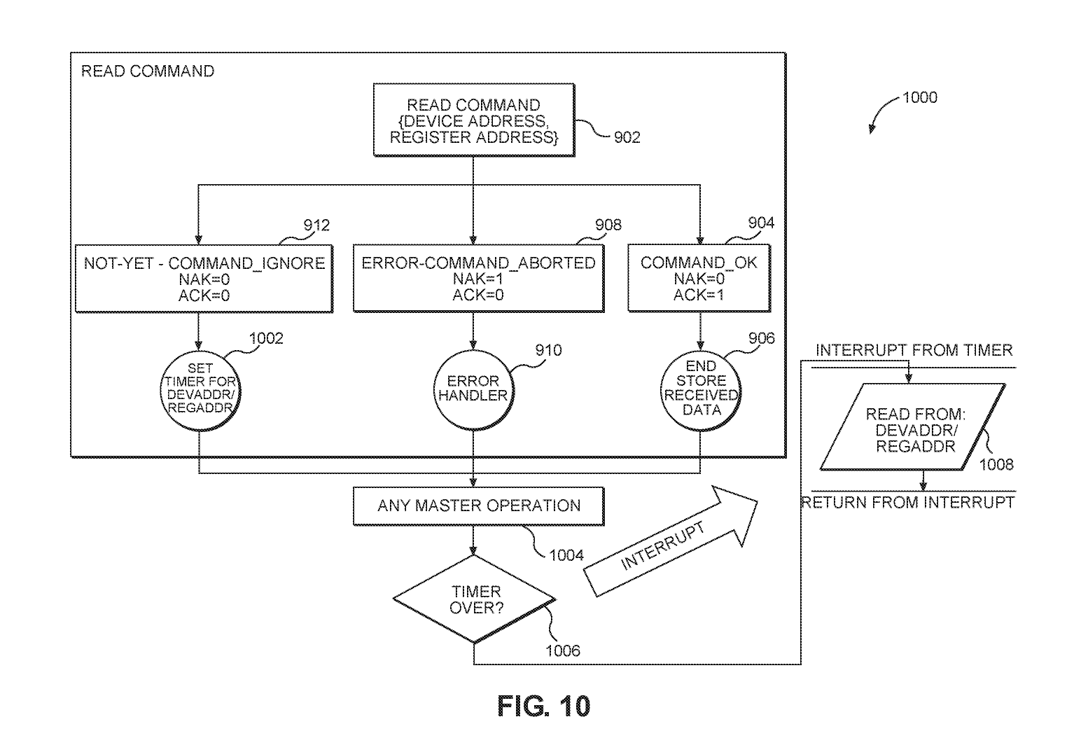

In another exemplary aspect, the master sets a timer using perhaps the timer 116 or another timer in the master after receipt of the not yet response and sends a renewed read command after expiration of the timer. This process is illustrated as process 1000 in FIG. 10. The process 1000 includes many of the same steps as process 900, and descriptions of those steps are not repeated. However, after receiving the not yet response, the master sets the timer 116 (block 1002). The master performs any other operations (block 1004) until the timer 116 expires (block 1006). After expiration of the timer 116, the timer 116 generates an interrupt and the master resends the read command (block 1008).

In an alternate aspect, not illustrated, the device may send additional bits to the master (e.g., using the RegData field in an Impdef way) indicating an expected time that will be required before the data is available. The master may then use this expected time to set the timer 116 or otherwise determine when to send the read command again.

In another alternate aspect, also not illustrated, the device may generate an interrupt that is sent to the master indicating that the fetch is over. The master, on receipt of the interrupt, stops its activities and initiates a renewed read command as soon as possible.

The systems and methods for providing split read transactions over an audio communication bus according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

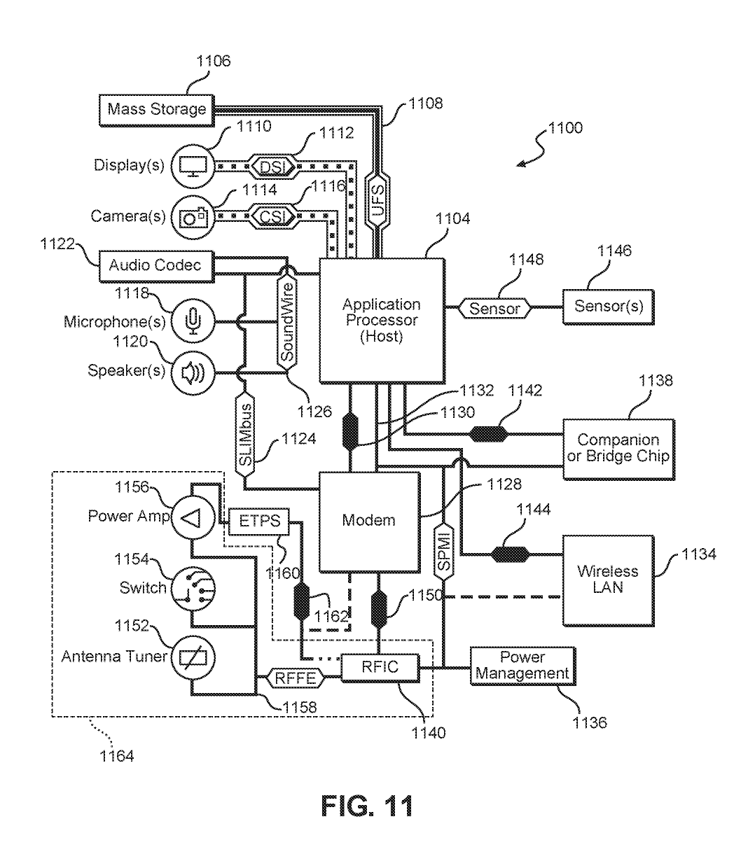

In this regard, FIG. 11 is a system-level block diagram of an exemplary mobile terminal 1100 such as a smart phone, mobile computing device tablet, or the like. While a mobile terminal having a SOUNDWIRE bus is particularly contemplated as being capable of benefiting from exemplary aspects of the present disclosure, it should be appreciated that the present disclosure is not so limited and may be useful in any system having a time division multiplexed (TDM) bus.

With continued reference to FIG. 11, the mobile terminal 1100 includes an application processor 1104 (sometimes referred to as a host) that communicates with a mass storage element 1106 through a universal flash storage (UFS) bus 1108. The application processor 1104 may further be connected to a display 1110 through a display serial interface (DSI) bus 1112 and a camera 1114 through a camera serial interface (CSI) bus 1116. Various audio elements such as a microphone 1118, a speaker 1120, and an audio codec 1122 may be coupled to the application processor 1104 through a serial low-power interchip multimedia bus (SLIMbus) 1124. Additionally, the audio elements may communicate with each other through a SOUNDWIRE bus 1126. A modem 1128 may also be coupled to the SLIMbus 1124 and/or the SOUNDWIRE bus 1126. The modem 1128 may further be connected to the application processor 1104 through a peripheral component interconnect (PCI) or PCI express (PCIe) bus 1130 and/or a system power management interface (SPMI) bus 1132.

With continued reference to FIG. 11, the SPMI bus 1132 may also be coupled to a wireless local area network (WLAN) IC (WLAN IC) 1134, a power management integrated circuit (PMIC) 1136, a companion IC (sometimes referred to as a bridge chip) 1138, and a radio frequency IC (RFIC) 1140. It should be appreciated that separate PCI buses 1142 and 1144 may also couple the application processor 1104 to the companion IC 1138 and the WLAN IC 1134. The application processor 1104 may further be connected to sensors 1146 through a sensor bus 1148. The modem 1128 and the RFIC 1140 may communicate using a bus 1150.

With continued reference to FIG. 11, the RFIC 1140 may couple to one or more RFFE elements, such as an antenna tuner 1152, a switch 1154, and a power amplifier 1156 through a radio frequency front end (RFFE) bus 1158. Additionally, the RFIC 1140 may couple to an envelope tracking power supply (ETPS) 1160 through a bus 1162, and the ETPS 1160 may communicate with the power amplifier 1156. Collectively, the RFFE elements, including the RFIC 1140, may be considered an RFFE system 1164. It should be appreciated that the RFFE bus 1158 may be formed from a clock line and a data line (not illustrated).

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A method of responding to a read command received from a master over an audio bus, the method comprising:
determining that data responsive to the read command is not available within a response window; and
returning a not yet response to the master.

2. The method of claim 1, further comprising receiving the read command.

3. The method of claim 1, wherein determining comprises determining that the data is in a memory element in a low-power state.

4. The method of claim 1, wherein determining comprises determining that the data is in a memory element accessed through a slow internal bus.

5. The method of claim 1, wherein determining comprises determining that the data is in a memory element accessed through a second external bus.

6. The method of claim 2, further comprising fetching the data from a memory element after receiving the read command.

7. The method of claim 6, further comprising providing the data to the master on receipt of a subsequent read command.

8. The method of claim 6, further comprising providing an interrupt to the master indicating the data is now available.

9. The method of claim 6, further comprising storing the data in a local register after fetching.

10. The method of claim 1, wherein returning the not yet response comprises setting a negative acknowledgement (NAK) bit to zero (0) and setting an acknowledgement (ACK) bit to zero (0).

11. The method of claim 1, wherein the audio bus comprises a SOUNDWIRE audio bus.

12. A method for reading data from a device across an audio bus, comprising:
sending a read command to the device across the audio bus;
receiving a not yet response from the device; and
sending a subsequent read command to the device.

13. The method of claim 12, further comprising sending the subsequent read command on receipt of the not yet response.

14. The method of claim 12, further comprising initiating a timer after receiving the not yet response and sending the subsequent read command on expiration of the timer.

15. The method of claim 12, further comprising receiving an interrupt from the device indicating the data is ready and sending the subsequent read command after receipt of the interrupt.

16. The method of claim 12, wherein the audio bus comprises a SOUNDWIRE audio bus.

17. An integrated circuit (IC) operating as a master on an audio bus, the IC comprising:
a bus interface coupled to the audio bus; and
a control system coupled to the bus interface and configured to:
send a read command to a device across the audio bus;
receive a not yet response from the device; and
send a subsequent read command to the device.

18. The IC of claim 17, further comprising a timer.

19. The IC of claim 17 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device, a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

20. An integrated circuit (IC) operating as a slave on an audio bus, the IC comprising:
a bus interface coupled to the audio bus; and
a control system coupled to the bus interface and configured to:
determine that data responsive to a read command is not available within a response window; and
return a not yet response to a master.

21. The IC of claim 20, wherein the control system is further configured to receive the read command.

22. The IC of claim 20, further comprising a memory element.

23. The IC of claim 22, wherein the control system is configured to determine that the data is in the memory element and the memory element is in a low-power state.

24. The IC of claim 22, wherein the control system is configured to determine that the data is in the memory element and the memory element is accessed through a slow internal bus.

25. The IC of claim 20, wherein the control system is configured to determine that the data is in a memory element accessed through a second external bus.

26. The IC of claim 20, wherein the control system is configured to return the not yet response by setting a negative acknowledgement (NAK) bit to zero (0) and setting an acknowledgement (ACK) bit to zero (0).

27. The IC of claim 20 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
